(19) United States
(12) Patent Application Publication
(10) Pub. No.: US 2010/0254753 A1
(43) Pub. Date: Oct. 7, 2010

(54) Plate member and support member connection

(76) Inventor: Anthony G. Mulholland, Mississauga (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 12/385,214

(22) Filed: Apr. 1, 2009

(51) Int. Cl. F16B 5/02

(52) U.S. Cl. 403/254

(57) ABSTRACT

A connection between a plate and a support member. The plate has a front surface and a rear surface with a hole therethrough. An annular groove extends into the front surface positioned radially outwardly from the hole defining an annular land between the hole and the groove. The support member has a front surface and a back surface with a hole therethrough. A bolt has a shaft between a head and a threaded portion. The head has an underside with an annular boss. The shaft is positioned through the plate hole with the head engaging the plate front surface, and the annular boss positioned in the annular recess. The threaded portion extends through the support member and a threaded nut is fixed thereon. The nut has an engaging face with protrusions. When the nut is tightened, the protrusions bite into the support member back surface.

### FIELD OF THE INVENTION

This invention relates to a connection for connecting two members together, in particular a planar plate member to a support member. More particularly, the connection is for connecting pallet rack upright frame members to lateral support members having brackets.

### BACKGROUND OF THE INVENTION

Storage racks for supporting pallets or the like are well known in the art. Conventional storage racks typically include an upright frame structure. The frame structure has vertical support posts spaced horizontally with lateral support beams having first and second ends fixed to the support posts at selected vertical elevations. The lateral support beams support pallets. Typically, lift trucks or other suitable devices are used to place and remove pallets on the support beams. In many applications, the storage racks are used to store inventory, and thus pallets are repeatedly added and removed from the support beams as inventory fluctuates. This results in cyclical loading of the support beams.

Conventional storage racks are almost always shipped unassembled and then assembled at a warehouse site. The method by which the support beams are connected to the vertical supports has been the focus of design. This is because the method of connection of the support beams and the vertical supports impacts the moment capacity of the connection and the flexural capacity of the beam, as well as the overall axial strength of the upright frame structure.

The vertical support members in the upright frame structure are usually hot-rolled structural steel C-shape channel members. These C-shape channel members typically have two columns of holes formed therein along their length. Brackets which are fixed to the ends of the lateral support beams also have holes. To assemble the upright frame structure, the holes in the brackets are aligned with the holes in the C-shape channel members, and threaded bolts are positioned through the holes and then threaded nuts are screwed onto the bolts. In order that the bolts fit into the holes, a diameter of the bolt must be smaller than a diameter of the hole. This results in an amount of mechanical play in the connection of the support beams and the vertical support posts. A problem exists in that small amounts of mechanical play allow rotation between the support beams and the vertical posts which makes the flexural behaviour of the lateral support beams somewhat unpredictable. The mechanical play also adds to the phenomenon that, over time, the bolts loosen from the nuts, in particular where the storage racks are subjected to cyclical loading.

Also, the members typically selected for the vertical posts are 3″ wide C-shape channels. The holes in the vertical posts must be sufficiently far from the edge of the C-shape channel such that a face of a nut, secured at the end of a bolt fitted through the holes, is flush against a web of the channel between flanges of the C-shape. If the face of the nut is partially in contact with the side walls of the flanges, the bolt and nut will be forced out of alignment with an axis of the holes. Because the holes in brackets of the horizontal beams must align with the holes in the C-shape channels, and the bracket on the left side of the C-shape channel cannot overlap the bracket on the right side of the C-shape channel, the holes in the brackets are positioned very close to the ends of the brackets. This results in an undesirable condition that typically reduces the moment capacity of the connection. The failure mode of the lateral support members when exposed to high moment loading is a tearing or fracturing of the material between the hole and the end edge of the bracket. The moment capacity of the connection between the vertical post and the horizontal beam is particularly of concern when the structure is subjected to seismic activity as the connections undergo high moment loads during a seismic event. Moving the holes in the C-shape channels closer to the flanges of the channel allows for the holes in the bracket to be further away from the edge thereby improving its moment capacity. However, this results in the mating surface of the nut and the C-shape channel to be non co-planar which produces undesirable forces in the shaft of the bolt when the nut is tightened.

There is a need for an improved storage rack to support pallets and the like having associated features, such as nuts and bolts, for connecting a horizontal beam to the vertical posts that obviates or mitigates at least one of the above identified disadvantages.

### SUMMARY OF THE INVENTION

The applicant has appreciated that the deflection and stress in the lateral support members can be significantly reduced if mechanical play is reduced or eliminated.

It is an object of this invention to eliminate mechanical play between the bracket of the lateral support beam and the vertical support member or post by introducing features that offer a secondary engagement between the bolt and the bracket, and the nut and the post. It is another object of the invention to include features that will enhance the ultimate moment strength of the connection by preferable locating the holes in the bracket such that they are further away from the edge of the material, and to utilize the secondary engagement features such that they prevent the material from fracturing in the zone between the bracket hole and the edge of the bracket.

These objects are achieved by the present invention which provides a connection between a plate and a support member. The plate has a front surface and a back surface. A circular hole is defined within a circumferential wall extending from the front surface to the back surface of the plate. An annular groove extends into the front surface towards the rear surface. The annular groove is positioned radially outwardly from the circumferential wall to define an annular land between the circumferential wall and the annular groove. The support member has a front surface and a threaded aperture extending into the support member from the front surface.

To connect the plate and the support member, the plate is positioned overtop of the support member with the hole aligned with the threaded aperture. A bolt has an elongated shaft with a head at a first end and a threaded portion at a second end. The head has an underside with an annular boss. The shaft is positioned through the hole with the head engaging the front surface of the plate, and the annular boss engaging in the annular recess. The threaded portion is threaded in the aperture to resist removal of the bolt.

Alternatively, the support member has a rear surface, and a hole extends through the support member from the front surface to the rear surface. A threaded nut is fixed on the threaded portion. The nut has an engaging face with protrusions so that when the nut is tightened, the protrusions bite into the back surface of the support member.

The combination of the engaged annular boss and annular groove and/or the at least one cutting projection on the nut reduce or eliminate mechanical play including rotation between the plate and the support member. The combination of the engaged annular boss and groove enhances the moment capacity of the connection between the plate and the support member providing enhanced resistance to a tearing of the plate member material adjacent the bolt as a result of the annular boss on the bolt engaging a larger volume of material on the plate.

The elimination or reduction of unrestricted rotation between the vertical support member and plate, for example bracket of a lateral support beam, results in a predictable semi-rigid connection that a designer can use in calculating beam stress and deflection, thus saving materials.

In one aspect, the present invention resides in a connection between a planar plate member and a support member, wherein: the planar plate member has a front surface and a rear surface, a circular hole through the plate member from the front surface to the rear surface, the hole is disposed about an axis normal to the front surface, the hole is defined within a circumferential wall extending between the front surface and the rear surface, the front surface having a circumferential juncture of the circumferential wall and the front surface, an annular groove extending into the front surface towards the rear surface positioned radially outwardly from the circumferential wall to define an annular land between the circumferential juncture and the annular groove, the support member having a front surface and an opening extending into the support member from the front surface disposed about an axis, the plate member overlying the support member with the rear surface of the plate member positioned in contact with the front surface of the support member and the axis of the hole aligned with the axis of the opening, a compression member comprising an elongate shaft having a first end and a second end, the shaft extending from the first end through the hole into the opening to the second end with the second end engaging the support member to resist withdrawal of the shaft forwardly relative to the front surface of the support member, a head member on the first end of the shaft extending radially outwardly from the shaft and carrying an annular rear surface engaging the front surface of the plate member about the hole, the annular rear surface comprising an annular boss fitting into the annular groove.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows an exploded view of the connection between a planar plate member and a support member;

FIG. 2 shows a section view of the connection in FIG. 1 horizontally through the upper bolt;

FIG. 3 shows a close-up detail view of the cross-section through the upper bolt shown in FIG. 2;

FIG. 4 shows a bolt having an annular boss provided proximate to a radial outermost circumference of the head;

FIG. 5 shows a bolt in accordance with another embodiment having an annular boss inset from the radial outermost circumference of the head;

FIG. 6 shows a bolt in accordance with another embodiment having a larger diameter portion proximate to a head of the bolt, with a tapered diameter section provided between a larger diameter portion and a shaft of the bolt;

FIG. 7 shows an exploded view of a connection between a planar plate member and a support member in accordance with another embodiment of the invention;

FIG. 8 shows a section view of the connection in FIG. 7 horizontally through the upper bolt;

FIG. 9 shows a close-up detail view of the cross-section through the upper bolt shown in FIG. 8; and

FIG. 10 shows a nut having four pointed projections.

### DETAILED DESCRIPTION OF THE PREFERRED EMBODIMENTS

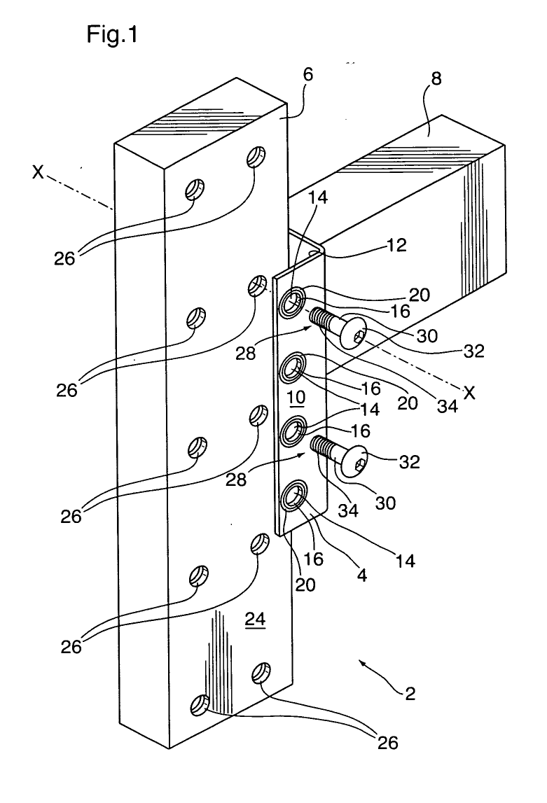

FIG. 1 shows, in exploded view, a connection 2 between a planar plate member 4 and a vertical support member 6. As shown, the planar plate member 4 is an angle bracket fixed to a horizontal beam 8.

The planar plate member 4 has a front surface 10 and a rear surface 12. Circular holes 14 extend through the plate member 4 from the front surface 10 to the rear surface 12. As shown, the holes 14 are disposed about an axis X-X normal to the front surface 10.

The circular holes 14 are defined within a circumferential wall 16 extending between the front surface 10 and the rear surface 12. A circumferential juncture 18 is defined at a merging of the circumferential wall 16 and the front surface 10.

An annular groove 20 extends into the front surface 10 of the plate member 2 towards the rear surface 12. The annular groove 20 is positioned radially outwardly from the circumferential wall 16 to define an annular land 22 between the circumferential juncture 18 and the annular groove 20. The annular groove 20 is co-axial with the axis X-X of the hole 14.

The vertical support member 6 has a front surface 24. Openings 26 extend into the front surface 24.

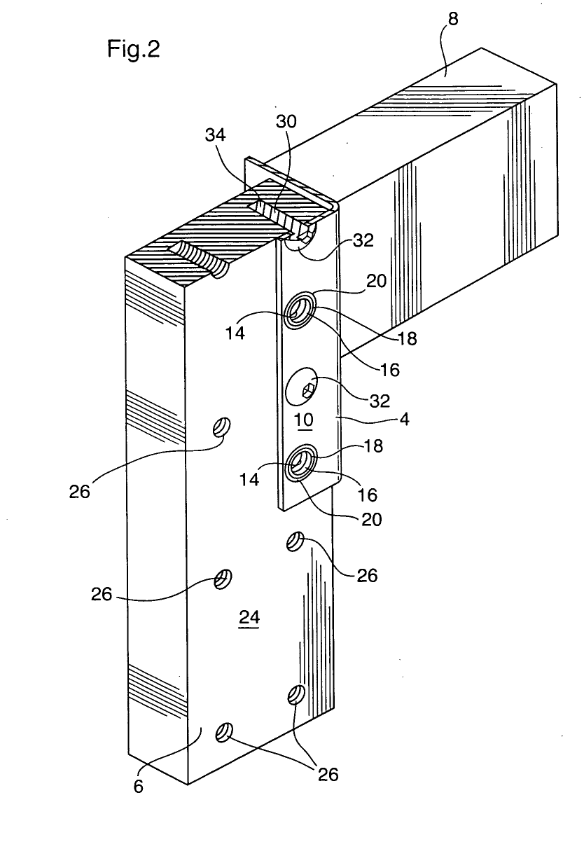

To connect the plate member 4 to the support member 6, the plate member 4 is positioned to overlie the support member 6 with the rear surface 12 of the plate member 4 positioned in contact with the front surface 24 of the support member 6. The axis of the hole X-X is aligned with an axis of the opening. Bolts 28 comprise an elongate shaft 30 having a first end 32 and a second end 34. The first end 32 comprises a head of the bolt. The second end 34 has a threaded portion. The second end threaded portion is inserted through the circular hole 14 and threaded into the threaded openings 26 of the support member 6 to resist withdrawal of the shaft 30 forwardly relative to the front surface 24 of the support member 6. This can best be seen in the cut-away section shown in FIG. 2.

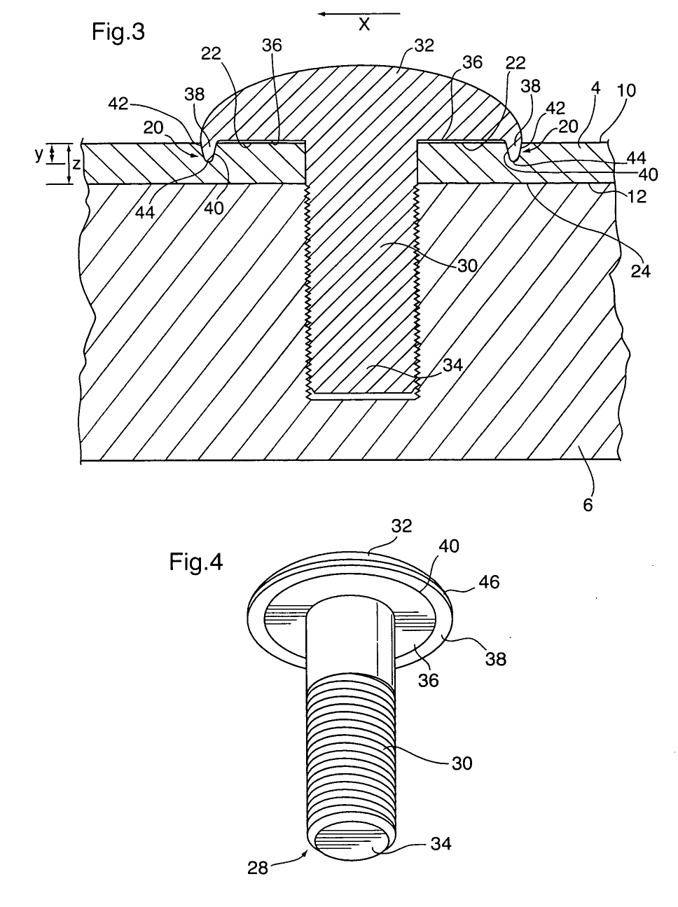

As shown in FIG. 3, an annular rear surface 36 of the head 32 engages the front surface 10, in particular the annular land 22 of the plate member 4. The annular rear surface 36 has an annular boss 38 which fits into and engages the annular groove 20. In this regard, the annular boss 38 has a shape complementary to that of the annular groove 20.

As shown in FIG. 3, the annular groove 20 is defined between a radially inner side wall 40 and a radially side wall 42. The radially inner side wall 40 and radially outer side wall 42 merge at a bight 44 forming a blind end. The bight 44 is concavely rounded.

As shown in the cross section in FIG. 3, the inner side wall 40 tapers rearwardly from the front surface 10 and radially outwardly. The outer side wall 42 tapers rearwardly from the front surface 10 and radially inwardly. The annular boss 38 has a complementary shape. The tapering of the inner side wall 40 and outer side wall 42, and complementary shape of the annular boss 38 assist in aligning the annular boss 38 in the annular groove 20.

Also, by having an annular boss 38 engaging the annular groove 20 of the plate member 4, result in eliminating mechanical play between the bolt 32 and the plate 4. The engagement of the annular boss 38 and the annular groove 20 also provide enhanced resistance to a material of the plate member 4 tearing in direction of arrow X. This is because of the contact of the annular boss 38 with the side walls of the annular groove 20, in particular the inner side wall 40 on the left hand side of the bolt shown in FIG. 3, and the outer side wall 42 on the right hand side of the bolt 32 shown in FIG. 3. It is preferred that the annular groove 20 extends into the planar plate member 4 a distance Y which is at most equal to ½ of a thickness Z of the planar plate member 4 between the front surface 10 and the rear surface 12. This is shown in FIG. 3 wherein the annular groove 20 extends a distance approximately ½ of a thickness Z of the planar plate member 4.

FIG. 4 shows the bolt 28 as shown in FIGS. 1 to 3. As shown, the head 32 has a radial outermost circumference 46, and the annular boss 38 is provided proximate to the radial outermost circumference 46. This maximizes a radial distance between the shaft 30 of the bolt 28 and the radially inner side wall 40 on the annular rear surface 36. As such, when the bolt annular rear surface 36 abuts against the annular land 22 of the plate member 4, with the annular boss 38 fitted within the annular groove 20, a maximum amount of material of the plate member 4 is positioned between the shaft 30 and the inner radial sidewall 40. This provides enhanced resistance to tearing of the edge area of the plate member 4 when the beam 8 is loaded with weight, such as a pallet.

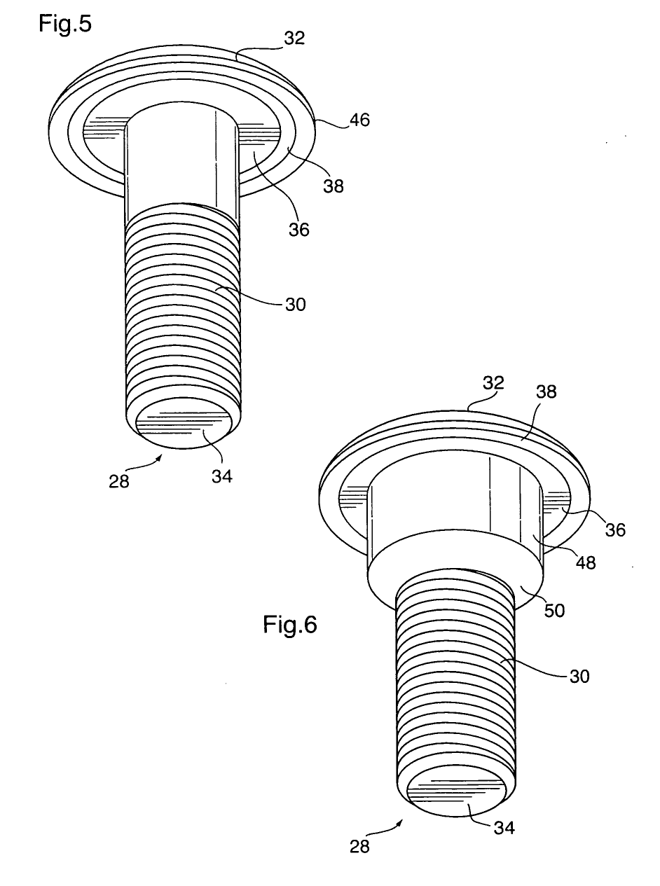

FIG. 5 shows an alternative embodiment of the bolt 28 whereby the annular boss 38 is provided inset from the radial outermost circumference 46 of the head 32.

FIG. 6 shows a further embodiment of the bolt 28. The bolt 28 has a larger diameter portion 48 provided proximate to the annular rear surface 36 of the head 32. The larger diameter portion 48 has a diameter larger than that of the shaft 30, but would be sized slightly smaller than a diameter of the circular hole 14 into which the bolt shaft 30 is inserted. A tapered section 50 is provided between the shaft 30 and the larger diameter portion 48, the tapered section having a first diameter at a position proximate to the larger diameter portion 48 and a second diameter proximate to the shaft 30. The first diameter is approximately equal to the diameter of the larger diameter portion 40. The second diameter is approximately equal to a diameter of a shaft 30. Between the first and second diameters, the diameter of the tapered section 50 reduces such that, when viewed in cross-section through a longitudinal axis of the bolt 28, the tapered section 50 has a linear face. The tapered section 50 better enables a user to insert the bolt 28 into a circular hole 14 when connecting the planar plate member 4 to the vertical support member 6 to assemble a storage rack.

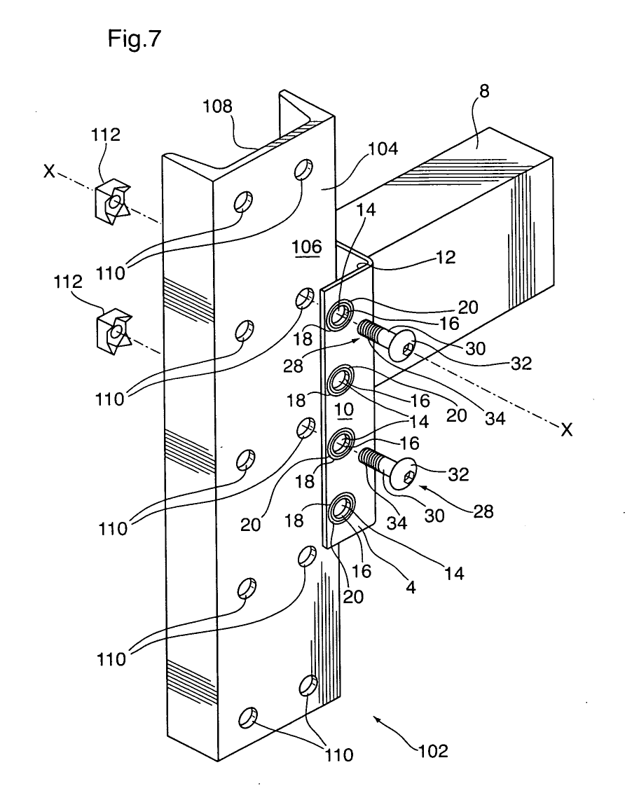

FIG. 7 shows a connection 102 in accordance with another embodiment of the present invention. Like reference characters have been used to designate like features for example as shown in FIG. 1.

In FIG. 7, a c-shaped channel member 104 is substituted for the vertical support member shown in FIG. 1. The c-shaped channel member 104 has a front surface 106 and a rear surface 108. Apertures 110 extend through an entire thickness of the c-shaped channel 104 from the front surface 106 to the rear surface 108.

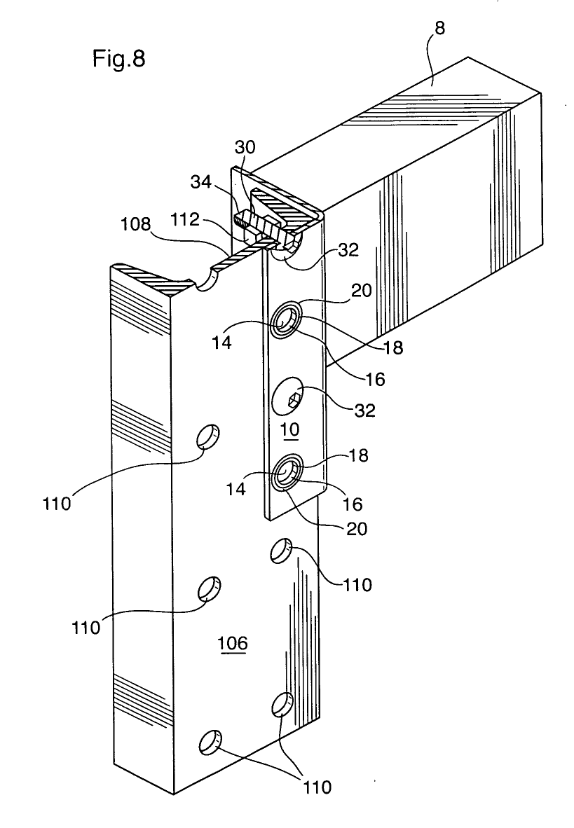

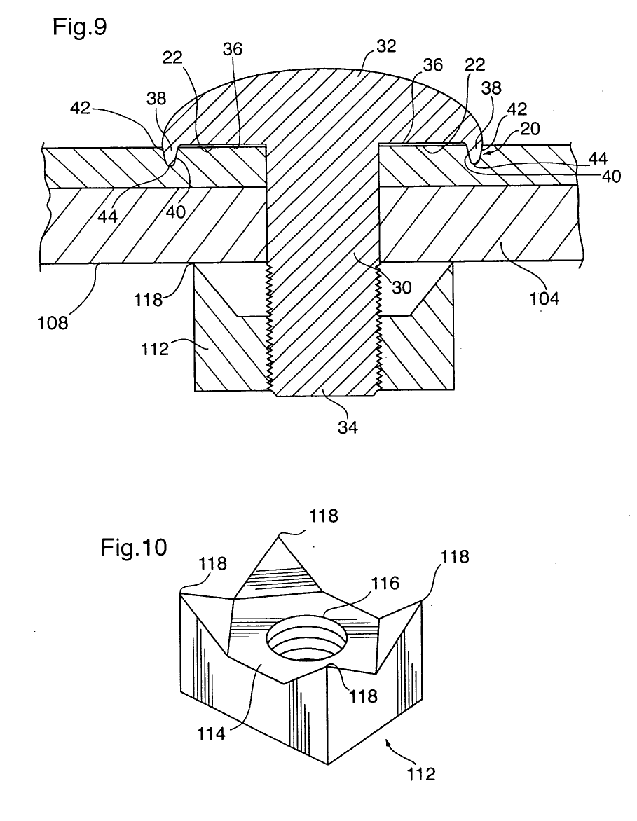

Nuts 112 are threadably secured to the second end 34 of the bolts 28, as shown in FIGS. 8 and 9.

As shown in FIG. 10, the nut 112 is cubic in shape and has an engaging face 114. A threaded aperture 116 extends through the cubic nut from the engaging face 114 to a back face of the nut (not shown). The engaging face 114 has pointed projection or claws 118 provided at each corner of the rectangular engaging face 114.

As shown in FIG. 9, when the nut 112 is secured to the second end 34 of the bolt 28, the pointed projections 118 bite into the rear surface of the c-shaped channel member 104. The biting engagement of the pointed projection 118 of the rear surface 108 reduces or eliminates mechanical play between the nut 112 and the c-shaped channel member 104.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It is understood that the bolt 28 shown in FIGS. 5 and 6 could be substituted for the bolt 28 shown in FIGS. 1 to 3 and 7 to 9.

It will be understood that, although various features of the invention have been described with respect to one or another of the embodiments of the invention, the various features and embodiments of the invention may be combined or used in conjunction with other features and embodiments of the invention as described and illustrated herein.

1. A connection between a planar plate member and a support member, wherein:
the planar plate member has a front surface and a rear surface, a circular hole through the plate member from the front surface to the rear surface, the hole is disposed about an axis normal to the front surface, the hole is defined within a circumferential wall extending between the front surface and the rear surface, the front surface having a circumferential juncture of the circumferential wall and the front surface, an annular groove extending into the front surface towards the rear surface positioned radially outwardly from the circumferential wall to define an annular land between the circumferential juncture and the annular groove,
the support member having a front surface and an opening extending into the support member from the front surface disposed about an axis,
the plate member overlying the support member with the rear surface of the plate member positioned in contact with the front surface of the support member and the axis of the hole aligned with the axis of the opening,
a compression member comprising an elongate shaft having a first end and a second end, the shaft extending from the first end through the hole into the opening to the second end with the second end engaging the support member to resist withdrawal of the shaft forwardly relative to the front surface of the support member, a head member on the first end of the shaft extending radially outwardly from the shaft and carrying an annular rear surface engaging the front surface of the plate member about the hole, the annular rear surface comprising an annular boss fitting into the annular groove.

2. The connection of claim 1, wherein the annular boss has a shape complementary to a shape of the annular groove.

3. The connection of claim 1, wherein the head has a radial outermost circumference, the annular boss is provided proximate the radial outermost circumference of the head.

4. The connection of claim 1, wherein the head has a radial outermost circumference, the annular boss is inset from the radial outermost circumference of the head.

5. The connection of claim 1, wherein the annular groove extends into the planar plate member a distance at most equal to one half of a thickness of the planar plate member between the front surface and the rear surface of the plate member.

6. The connection of claim 1, wherein the annular groove is coaxial about the axis of the hole.

7. The connection of claim 1, wherein the annular groove is defined between a radially inner side wall and a radially outer side wall merging at a bight forming a blind end of the groove, when viewed in a cross-section radially about the axis of the hole the inner side wall tapering rearwardly from the front surface and radially outwardly, the outer side wall tapering rearwardly from the front surface and radially inwardly.

8. The connection of claim 7, wherein the bight is concavely rounded.

9. The connection of claim 8, wherein the annular boss has a shape complementary to a shape of the annular groove.

10. The connection of claim 1, wherein the compression member is a bolt with the head fixedly secured to the shaft at the first end of the shaft.

11. The connection of claim 10, wherein the opening extending into the support member has threads and the second end of the shaft has threads so that the second end is threadably engageable with the threaded opening of the support member to resist withdrawal of the shaft forwardly through the opening in the support member.

12. The connection of claim 10, wherein the support member has a rear surface, the opening extending through an entire thickness of the support member from the front surface of the support member to the rear surface of the support member, the second end of the shaft has threads, the compression member further comprising a nut element threadably engageable on the shaft, such that the bolt is positioned with the shaft extending through the hole and opening and the nut is threaded onto the second end of the shaft and tightened against the back surface of the support member to resist withdrawal of the shaft forwardly through the opening in the support member.

13. The connection of claim 12, wherein the nut has at least one pointed projection engaging the back surface of the contact member.

14. The connection of claim 12, wherein the shaft of the bolt has a larger diameter portion provided proximate to the first end of the bolt adjacent the annular rear surface of the head, the larger diameter portion has a diameter larger than a diameter of the shaft but slightly smaller than a diameter of the circular hole through the plate member.

15. The connection of claim 14, wherein a tapered section is provided between the shaft and the larger diameter portion, the tapered section having a first diameter at a position proximate to the larger diameter portion and a second diameter proximate to the shaft, the first diameter is equal to the diameter of the larger diameter portion and the second diameter is equal to the diameter of the shaft, a diameter of the tapered section decreases linearly between the first diameter to the second diameter.

16. The connection of claim 15, wherein the planar plate member is a bracket fixed to an end of a horizontal beam of a storage rack, and the support ember is a vertical post of the storage rack.

17. The connection of claim 1, wherein the planar plate member is a bracket fixed to an end of a horizontal beam of a storage rack, and the support ember is a vertical post of the storage rack.
